(19) United States
(12) Patent Application Publication
(10) Pub. No.: US 2009/0047434 A1
(43) Pub. Date: Feb. 19, 2009

(54) Flavor or Fragrance Capsules

(76) Inventor: Gil Trophardy, Gex (FR)

Correspondence Address: WINSTON & STRAWN LLP;PATENT DEPARTMENT, 1700 K STREET, N.W., WASHINGTON, DC, 20006, US

(21) Appl. No.: 12/091,427

(22) PCT Filed: Oct. 30, 2006
(86) PCT No.: PCT/IB06/54008

§ 371 Date: Apr. 24, 2008

(30) Foreign Application Priority Data
Nov. 11, 2005 (EP) 05110646.6

(51) Int. Cl. B05D 3/04

(52) U.S. Cl. 427/377

(57) ABSTRACT

The present invention relates to capsules encapsulating a flavor or fragrance ingredient, the capsules being obtainable by a method in which an emulsion comprising the ingredient is dispersed in the form of drops in a spraying tower and exposed to a temperature in the range of 121 to 250° C. In the tower, a cloud of suspended powdering agent provides a coating and prevents the capsules from sticking together. The capsules have a high ingredient load of about 18-40 wt. % and a particle size in the range of 100 to 2000 μm. The method for obtaining the capsules has the advantage of substantially less loss of ingredient during drying compared to similar processes of the prior art.

### TECHNICAL FIELD

The present invention relates to a method for preparing capsules having an average diameter in the range of 100 to 2000 μm, more particularly from 200 to 800 micron, and encapsulating a flavor and/or fragrance ingredient. The invention further relates to capsules as such, a method for reducing loss of ingredients during preparation of the capsules and the use of a multi stage drying apparatus for preparing capsules of the invention.

### Background of the Invention and Problem to be Solved

The objective of the present invention is the encapsulation of flavour and/or fragrance compounds and/or compositions in particles having an average diameter of 100 to 2000 μm and more particularly 200 to 800 μm. Encapsulation, in general, has the purpose of providing a stable and transportable form of an active ingredient. If the active ingredient is liquid at ambient temperature, encapsulation within particles has the further advantage of providing easier handling and mixing with dry products and a less concentrated form of the active ingredient, the latter being an advantage in some instances

Encapsulation of active ingredients in free flowing powders also generally has the purpose of creating a form of active ingredients that can conveniently be dosed and mixed with other ingredients or be directly added to consumer end products. In this regard, particle size and load of active ingredient become relevant. Relatively large particles become useless if small quantities of active ingredient are to be added to a consumer end product, because the fluctuations of final concentration of the active ingredient may become quite considerable. Relatively small particles, on the other hand, suffer from a less beneficial surface to volume ratio. This ratio is particularly relevant with volatile active ingredients, such as many fragrances and flavours, where loss through evaporation needs to be prevented. Furthermore, the smaller the particles, comprising potentially combustible active ingredients, the higher the risks of explosion while handling, thus requiring particular handling precautions which have a bearing on cost-efficiency.

Spray-drying methods, for example, have been used for some time to encapsulate flavours and/or fragrances in glassy matrices and are extensively disclosed in the prior art. Typically, drops of a suspension are sprayed through a nozzle in a spraying tower where they are exposed to hot air, causing the evaporation of water and thus formation of dried particles which are generally collected at the bottom of the drying tower. However, typical spray-drying is not suitable to produce capsules of higher than about 100 μm, because drying of these large drops would not be sufficiently quick to prevent sticking of the drops to the inner wall of the tower. A further drawback of traditional spray-drying methods is the fact that relatively low viscosity suspensions or emulsions have to be employed, with a viscosity upper limit of about a few hundred mPas, in order to allow reliable atomisation. Low viscosity is generally achieved with a high water content (about 40 wt. %) of the reactive mixture, but this in turn requires evaporation of the water during the drying process. It goes without saying that a drying process in which high amounts of water need to be removed is more costly. From the above it can clearly be deduced that spray-drying is not suitable for producing particles having a particle size in the range of 100-2000 μm. In addition, while being rather simple and well understood, spray-drying only allows processing of low viscosity slurries.

The prior art of pertinence in the field of the invention has addressed the shortcomings of traditional spray-drying methods. For example, WO 04/062382 describes a process for producing beadlet preparations of fat-soluble substances, wherein an aqueous suspension of a fat-soluble substance is fed into a spray tower while simultaneously introducing powder starch and hot air, through separate inlets, into the spraying tower. This process is said to be carried out at a temperature of up to 200° C., but preferably from 60-120° C. in the spray zone, and the fat-soluble substance is a vitamin, such as vitamins A, D, E, K, a carotenoid, a polyunsaturated fatty acid, an oil or a fat. The latter are substances which are not particularly volatile and could therefore be optimally preserved in relatively dense beadlets. There is no mention however of the problems that may be encountered when trying to encapsulate volatile substances, which require particular precautions against evaporation, nor of the encapsulation of hydrophilic actives, not soluble in fats and which constitute a particular interest of the present invention.

WO 91/17821 describes a process for preparing microcapsules containing a flavorant embedded in a matrix material by spraying an aqueous suspension under the supply of air having a temperature of 50 to 120° C., while simultaneously introducing a spraying agent. The spraying agent may comprise starch, modified starch, tri-calcium phosphate and others. This reference clearly states that in conventional spray drying hot air having a temperature of typically 180-300° C. is supplied. Furthermore, several disadvantages of spray-drying are mentioned, and it is indicated that bigger particles than those obtained by spray drying would be desirable and provide advantages.

Moreover, from some examples of WO 91/17821 it can be seen that the encapsulation process according to this teaching suffers a substantial loss of up to 50 wt. % of the flavourant material present in the initial emulsion (Examples 1, 3 and 4). The aim of the present invention is precisely to produce flavour and/or fragrance particles in a way that reduces substantially the flavor losses, for example, that not more than 20 wt. %, and preferably less than 10 wt. % of the flavour and/or fragrance material is lost during the preparation of the capsules. It is a further objective to obtain capsules with a higher flavour/fragrance load.

### SUMMARY OF THE INVENTION

According to the invention there is provided a process for encapsulating volatile ingredients in capsules having a diameter in the range of 100 to 2000 μm, and more preferably between 200 and 800 μm, wherein the ingredient to be encapsulated is sprayed into a cloud of powdering agent, the process being characterized in that the temperature of the air supplied into the tower for drying is above 121° C. Surprisingly, the loss of volatiles remained significantly lower than in processes of the prior art, where lower temperatures of the supplied air are used.

Accordingly, the present invention provides, in a first aspect, a method for preparing capsules having an average diameter in the range of 100 to 2000 μm encapsulating a flavour and/or fragrance ingredient (hereinafter “ingredient”), the method comprising the steps of
a) preparing an aqueous solution, suspension and/or emulsion (hereinafter simply “emulsion”) comprising the flavour and/or fragrance ingredient in a dissolved, suspended and/or emulsified form (hereinafter simply “emulsified”), matrix materials and water,
b) spraying the emulsion in the form of drops having a mean diameter of 100 to 2000 μm into a spraying tower,
c) introducing, simultaneously to the spraying-step, a powdering agent into the spraying tower to obtain a coating of powdering agent on the drops of the sprayed emulsion,
d) supplying, simultaneously to the spraying step, a hot gas into the spraying tower, and,
e) removing capsules comprising a coating of powdering agent from the spraying tower,
   the process being characterized in that the temperature of the hot gas supplied in step e) is in the range of 130-250° C.

The present invention also relates to the capsules obtainable by the method of the invention, which present a content in encapsulated material which is surprisingly high compared to those that could be obtained with prior art processes of the same type.

Thus, the present invention further provides capsules having an average diameter in the range of 100 to 2000 μm encapsulating a flavour and/or fragrance ingredient, the load of the ingredient being in the range of 18-50 wt. %, preferably 20-40 wt. %, the capsules being provided with a powdering agent coating, whereby the coating provides 0.1 to 30 wt. % of the total weight of the capsule.

In a fourth aspect, the present invention provides a method for reducing loss of flavour and/or fragrance ingredient during the preparation of capsules having an average diameter in the range of 100 to 2000 μm, the method comprising the step of dispersing a suspension and/or emulsion comprising the flavour and/or fragrance ingredient, matrix materials and water into a spraying tower, wherein the spraying tower is further supplied with a hot gas having a temperature in the range of 130 to 250° C. and wherein simultaneously a powdering agent is introduced into the spraying tower.

In a fifth aspect, the present invention provides the use of a multi stage drying apparatus for preparing capsules according to the method of the present invention.

The process of the present invention provides a number of important advantages over the processes known from the prior art. First of all, the fact that higher temperatures may be used leads to a substantial reduction of loss of ingredient. The higher temperature also enables shorter residence time of the capsules in the tower and/or fluidised bed, which allows for a more speedy process. The higher temperatures allow quicker drying and, as a consequence, less drying/powdering agent needs to be added than in the prior art methods. Accordingly, the coating provided by the powdering agent is substantially thinner. This, in turn, allows for higher load of the active ingredient in the capsules

### BRIEF DESCRIPTION OF THE DRAWING

FIG. 1 shows the loss of limonene during encapsulation in a glassy matrix in a multi-stage drying apparatus at air inlet temperatures according to the present invention. It can be seen that by spraying drops of an emulsion comprising limonene into a circulating suspension of native starch in the drying tower, higher temperature of the main inlet air stream results in lower loss of flavour, with better results being obtained at 170° C. than at 140° C.

### DESCRIPTION OF THE DETAILED EMBODIMENTS OF THE INVENTION

The present invention provides a method for preparing capsules having an average diameter in the range of 100 to 2000 μm encapsulating a flavour and/or fragrance ingredient. Preferably, the average diameter is in the range of 200 to 800 μm, more preferably 300 to 500 μm. The term “average” and/or “mean” as used, for example, in the expression “average diameter”, refers to the arithmetic mean.

The method of the present invention may be performed in any conventional spraying tower such as described in WO 2004/062382 (page 2, lines 26-35), for example. Surprisingly, it has now been established that a conventional multi-stage drying apparatus can be used for conducting the steps of the method of the present invention. A multi-stage drying apparatus comprises a spray drying tower, and, at the bottom of the tower, a fluidised bed intercepting partially dried particles which have fallen across the tower. In a typical multi-stage drier, an air inlet and an air outlet are situated in the upper region of the tower. Generally, it is possible to maintain, in these devices, a suspension of fine particles herein referred to as a “powdering agent”, as is required for the purpose of the present invention. The powdering agent is generally introduced by a separate inlet that may preferably be situated either close to the inlet of the aqueous emulsion or in the lower part of the drying tower. The powdering agent is, in the operation mode, in constant movement and may exit the tower together with the air outlet.

The present invention thus provides a new utility of classic multi stage spray driers and, in addition enables the preparation of relatively large-sized capsules according to the method herein disclosed with a non-specialised equipment. The use of such a multistage dryer enlarges the encapsulation possibilities and variety. Accordingly, in an embodiment, the invention provides a method which is conducted in a multi stage drying apparatus.

The capsules produced according to the present invention have an average diameter in the range of 100 to 2000 μm. The size of the capsules is determined by the size of the drops that are dispersed into the drying tower according to a step of the method of the invention. According to an embodiment of the invention, the step of dispersing the emulsion is performed by guiding the emulsion through a spraying nozzle or through a centrifugal wheel disk into the spraying tower. Other devices may be used to disperse the emulsion in the form of drops of a controlled average size. For instance vibrated orifices may be used instead.

If a spraying nozzle is used for dispersing the drops the size may be controlled by the flow rate of an atomising gas through the nozzle, for example.

In the case where a centrifugal wheel disk is used for dispersal, the main factor for adjusting droplet size to the terms of the present invention is the centrifugal force with which the drops are dispersed from the disk into the tower. The centrifugal force, in turn, depends on the speed of rotation and the diameter of the disk. The feed flow rate of the emulsion, its viscosity and surface tension are also parameters controlling the final drop size and size distribution. By adjusting these parameters, the skilled person can control the size of the drops of the emulsion to be dispersed in the tower.

The method of the present invention comprises the step of preparing an aqueous solution, suspension and/or emulsion (hereinafter simply “emulsion”) comprising the flavour and/or fragrance ingredient in a dissolved, suspended and/or emulsified form, matrix materials and water.

Within the context of this specification the word “comprises” is taken to mean “includes, among other things”. It is not intended to be construed as “consists only of”.

The flavour and/or fragrance ingredient may thus be mixed with a carrier system by dissolving it together with a matrix material, by suspending and/or by emulsifying it therein. For the sake of convenience, the term emulsifying is used to encompass all the different forms of mixing the ingredient with the inert matrix materials.

The ingredient may be hydrophilic and/or hydrophobic. Accordingly, the invention is applicable to a large family of ingredients including water soluble ones, such as juices, reaction flavours, for example. The ingredient may also comprise a combination of hydrophilic and hydrophobic components. If the ingredient is hydrophilic, it will generally be dissolved in the aqueous solution together with the matrix materials. According to a preferred embodiment, the ingredient comprises hydrophobic components, while the matrix materials may be soluble in water. Generally, in this case, the hydrophobic ingredient is emulsified in the form of small droplets having an average diameter in the range of 0.5-10 μm, preferably 1-5 μm for example, within the matrix materials. Emulsification may be made, for example, by using a high pressure homogeniser or a colloid mill.

A flavour and/or or fragrance ingredient, herein referred to as “ingredient” encompasses flavour and fragrance ingredients or compositions of current use in the flavour and/or fragrance industry, of both natural and synthetic origin. It includes single compounds and mixtures. The capsules used in the invention can encapsulate volatile or labile ingredients in liquid form, preferably with a log P in the range of −2 and 7, preferably 2-6. Specific examples of such components may be found in the current literature, e.g. in Fenaroli's Handbook of flavour ingredients, 1975, CRC Press; Synthetic Food adjuncts, 1947 by M. B. Jacobs, edited by Van Nostrand; or Perfume and Flavor Chemicals by S. Arctander, 1969, Montclair, N.J. (USA). Many other examples of current perfumery ingredients to be encapsulated as herein taught may be found in the patent and general literature available.

Accordingly, in a preferred embodiment, the ingredient is selected from the group consisting of a flavour and/or fragrance compound or composition, a flavour or fragrance natural extract, and a mixture of any of the before mentioned ingredients.

Flavour and/or fragrance ingredients are well known to a person skilled in the art of aromatising and/or providing a pleasant odour to consumer products, i.e. of imparting an odour or a flavour or taste to a consumer product, or of modifying the taste and/or odour of said consumer product, or yet its texture or mouthfeel. Natural extracts can also be encapsulated into the system for flavouring or perfuming consumer end products. Examples of these include citrus extracts such as lemon, orange, lime, grapefruit, or mandarin oils or coffee, tea, mint, cocoa or essential oils of herbs and spices between other.

Other examples of flavour and/or fragrance ingredients are synthetic flavour and/or fragrance oils, flavouring aromatics and natural extracts such as oils, essential oils, oleoresins and other extracts derived from plants, for example from leaves, flowers, fruits, roots, rhizomes, stem, and so forth.

Other flavours included by the term ingredient are reaction flavours, or process flavours. These flavours may be obtained by heating food ingredients and/or ingredients, which are permitted for use in foodstuffs or in process flavourings. A nitrogen source and a carbohydrate source are necessary to perform a Maillard reaction for obtaining process flavours.

The flavour and/or fragrance ingredient may be present in the form of a mixture with solvents, adjuvants, additives and/or other components, generally those of current use in the fragrance and/or flavour industry.

Preferably, the ingredient or composition is liquid at 60° C. More preferably, it is liquid at 40° C. Most preferably, it is liquid at room temperature (RT=25° C.).

A typical characteristic of flavour and/or fragrance compositions is the high proportion of volatile compounds and/or components. Accordingly, in an embodiment, the active ingredient or composition to be encapsulated according to the invention comprises at least 10 wt. %, preferably at least 20 wt. %, more preferably at least 30 wt. % and most preferably at least 40 wt. % by weight, relative to the weight of the composition, of chemical compounds having a vapour pressure of ≧0.007 Pa at 25° C.

Preferably, at least 10 wt. % by weight have a vapour pressure of ≧0.1, more preferably at least 10 wt. % have a vapour pressure of ≧1 Pa at 25° C., and most preferably, at least 10 wt. % have a vapour pressure of ≧10 Pa at 25° C.

Compounds having a vapour pressure equal to or above 0.007 Pa at 25° C. are generally regarded as having a volatile character and benefit the most from encapsulation processing.

The limit of 10 wt. % of such compounds is regarded to constitute a substantial part of the active ingredient or composition. The method of the present invention, however, also allows for efficient encapsulation of more volatile ingredients, present in higher amounts in the composition than those cited above.

For the purpose of the present invention and for the sake of convenience, the vapour pressure is determined by calculation. Accordingly, the method disclosed in “EPI suite”; 2000 U.S. Environmental Protection Agency, is used herein to determine and define the concrete value of the vapour pressure of a specific compound or component of the active ingredient. This software is freely available and is based on average values of vapour pressures obtained by various scientific methods.

In the context of the present invention, percentages relative to the capsules are percentages by weight of dry matter, unless otherwise indicated. Similarly, if proportions are indicated as parts, parts of weight of dry matter are meant. In case that water is indicated as part of a composition, such as a composition of different ingredients, of a solution, emulsion, for example, percentages refer, of course, to the total weight of the composition, including water.

Matrix materials useful in the preparation of an emulsion in a step of the present invention have the purpose of providing a carrier for the ingredient. Preferably, the matrix materials are selected as to their capacity of forming a glassy matrix during the drying of the emulsified dispersed drops. A glassy matrix is an amorphous solid characterized by viscosities of the order in the range of about 1010 to 1012 Pa*s and an extremely low molecular mobility. A good understanding of the glassy state is provided by Dominique Champion et al in “Towards an improved understanding of glass transition and relaxations in foods: molecular mobility in the glass transition range”, Trends in Food Science and Technology 11 (2000) 41-55.

Matrix components may be selected, for example, from polymers, namely proteins, polymeric carbohydrates, and other polymeric materials. The polymeric materials preferably comprise hydrophilic polymers in order to provide an effective oxygen-barrier. Accordingly, the matrix may comprise hydrocolloids. In addition, polymers being less soluble in water, that is, more hydrophobic polymers may be present in the matrix, too, in order to provide some lipophilic character to the glassy matrix and thus to provide protection against moisture. In addition, the matrix may contain further components that are not polymeric, buts that may assist in the formation of a dense glassy matrix or that may be added for another purpose.

Suitable matrix components optionally associated with or part of the flavour capsules of the invention may thus comprise proteins, for example caseins, whey proteins, soy protein, and/or gelatine, for example. These proteins have good emulsification and film forming properties and can thus form the basis for polymer matrices. Preferably, the matrix components comprise carbohydrates. The matrix components may comprise water soluble and non-water soluble carbohydrates.

For example the matrix component may comprise monosaccharides, disaccharides, trisaccharides and/or oligosaccharides, for example. Acccordingly, in a preferred embodiment of the present invention, the matrix materials comprise polysaccharides, and, in addition, saccharides selected from the group of mono- and/or disaccharides.

Preferably, the matrix component comprises polysaccharides, that is, saccharides containing more than 10 monosaccharide units per molecule. Likewise, the matrix component may comprise gums and/or hydrocolloids, for example, gum arabic and the like.

More preferably, the matrix component comprises a starch and/or a starch derivative such as pre-gelatinised starch, thin- or thick-boiling starch, dextrins or maltodextrins of various molecular weights. Other possible modifications of starch and resulting derivatives suitable as a matrix component include octenyl-succinated starch, starch ethers (i.e. carboxymethyl starch), starch esters (i.e starch monophosphate), crosslinked starch and/or oxidised starch.

Preferably, the matrix component comprises dextrin, more preferably maltodextrin and/or corn syrup. Most preferably, the matrix component comprises maltodextrin and/or corn starch syrup having a mean dextrose equivalence of 5-25, preferably 6-20, more preferably 10-18.

In a preferred embodiment, the matrix component comprises, per dry weight of the glassy matrix alone, 60-95 wt. % of maltodextrin, preferably with a DE value in the above indicated ranges, and 5-40 wt. % of modified starch, such as alkenyl-succinated starch, (in particular octenyl-succinated starch).

While the above matrix-materials are preferred in case of applications of the capsules to food products and/or beverages, there may be numerous further materials suitable in case that the capsules are not intended for addition to food products. For example, in capsules comprising fragrance ingredients, the matrix material may be selected from a much wider range of materials. For example, synthetic polymers, co-polymers or natural non-food polymers, salts and other fillers may be used as matrix materials.

The emulsion prepared in a step of the present method preferably comprises 10-70 wt. % of matrix materials, 30-70 wt. % of water and 5-35 wt. % of the active ingredient or composition to be encapsulated. More preferably, the percentages are respectively in the ranges of 20-40, 40-60 and 10-30 wt. %, and most preferably in the ranges 25-35, 45-55 and 15-20 wt. % of matrix materials, water and ingredient, respectively, in the emulsion.

According to a preferred embodiment of the method of present invention, the emulsion comprising the ingredient, matrix components and water has a dry matter content in the range of 45-80 wt. %, preferably 50-70 wt. %. The relatively high dry-matter content provides a high viscosity emulsion, the latter possibly presenting difficulties in handling and guidance into the spraying tower. On the other hand, thanks to a high dry-matter content, the drying process becomes more efficient as less water needs to be evaporated. Unlike in conventional spray drying, where the emulsion viscosity needs to be low enough to produce fine droplets having a diameter of generally less than 150 μm, the present invention enables the preparation of comparatively large drops to be dried successfully and efficiently. In this case, it is not necessary for the emulsion to have a low viscosity, but, if compared to conventional spray drying, higher viscosities may be used.

Such emulsions with high dry-matter content lead to the large size capsules of the present invention, resulting from the large size drops dispersed in the drying tower.

The present invention comprises a step of introducing, simultaneously to the spraying-step, a powdering agent into the spraying tower to obtain a coating of powdering agent on the drops of the sprayed emulsion. According to a preferred embodiment, the powdering agent is selected from the group consisting of starch, starch derivatives, talc, bentonite, silicon dioxide, calcium, magnesium, aluminium or potassium silicates, sodium, potassium or calcium aluminosilicates, calcium, sodium, or magnesium carbonates, calcium or magnesium phosphates, ferric ammonium citrate, microcrystalline cellulose and cellulose derivatives or fibers, aluminium, calcium, sodium, magnesium, potassium or ammonium salts of fatty acids, magnesium oxides and mixtures comprising two or more of the aforementioned powdering agents. The purpose of the powdering agent is to prevent the dispersed drops from attaching to each other and/or to the inner walls of the spraying tower. The powdering agent is thus suspended in the tower and creates a coating on the dispersed drops as soon as they enter the tower. Accordingly, in a preferred embodiment of the invention, particles of the powdering agent are suspended in the spraying tower and circulate from an inlet to an outlet of the spraying tower, which outlet is also the outlet of the hot gas.

Generally, the powdering agent itself is circulating from the inlet into the drying tower, from which it generally exits together with exhaust gas at the exhaust gas outlet. The powdering agent may be recycled in a cyclone collector from which it may be redirected by a powdering agent return pipe to the inlet into the spraying tower. Preferably, the powdering circulates at least in part in counter current with the dispersed drops. Accordingly, in a preferred embodiment of the invention, spare powdering agent not absorbed on the dispersed capsules exits the spraying tower together with the hot gas through an outlet of exhaust gas, which leads to a cyclone or a filter bag house able to separate the hot gas from the powdering agent, the powdering agent being then re-introduced into the spraying tower. There is thus a continuous circulation of powdering agent from the cyclone to the spraying tower and back to the cyclone.

The method of the present invention comprises the essential step of supplying, simultaneously to the dispersing step, a hot gas having a temperature in the range of 130-250° C. into the spraying tower. The hot gas is supplied at a higher temperature than that disclosed in the prior art, in particular in WO 91/17821, and also higher than the preferred temperature of WO 04/062382, the latter not relating to the encapsulation of flavours and/or fragrance ingredients, that is, generally volatile ingredients.

It was surprisingly established that relatively large-sized drops comprising the encapsulated ingredient are preferably dried under supply of a gas having a higher temperature than that prior taught, whilst simultaneously improving on the loss of volatiles during drying.

This result is totally unexpected, as it is well-known in the art of spray drying encapsulation methods that the use higher drying temperatures generally entails a higher loss of volatiles. Without wishing to be bound by theory, it is hypothesized that the higher temperature in the spraying zone brought about by the higher temperature of the inlet gas stream results in a shorter drying time. According to the invention, more water is evaporated from the droplet during its flight at high temperature, and the subsequent drying time in the fluidised bed can thus be shortened. It is believed that the subsequent drying by hot air in the fluidised bed takes longer in the prior art methods and may result in substantial further loss or degradation of ingredients.

According to a preferred embodiment, the hot gas supplied into the drying tower has a temperature in the range of 135-220° C., preferably 140-210° C., and most preferably 150-190° C.

The hot gas may be air or nitrogen, for example.

The supply of hot gas through a hot gas inlet results in a temperature in the spraying tower in the range of about 180 to about 50° C., preferably about 170° C. to about 40° C. The temperature in the tower follows a gradient, with the highest temperature at the hot gas inlet, which thus provides a high temperature at the spraying zone. At the bottom of the tower the temperature is much lower, due to the evaporation of water from the dispersed drops.

The method of the invention also comprises the step of removing the capsules coated with powdering agent from the spraying tower.

The method of the present invention described above may be carried out batch-wise or continuously. In a multi-stage drier, a batch-wise operation may be chosen. Accordingly, there is an exit at the level of the fluidised bed leading to a collecting vessel. By switching off the fluidised bed and opening the valve leading to the collecting vessel, capsules are guided, for example by gravity, to the collecting vessel, from where they may be removed. In a preferred embodiment, the method of the invention is performed continuously, for example by conveying the granules from the integrated fluidised bed to an external, additional fluidised bed where the capsules may be further dried to accurately control their final moisture content. In practice, according to the process of the invention, the residence time of the capsules in the whole process is reduced, resulting in a better quality product.

According to a preferred embodiment, the method of the invention comprises a further step of intercepting the capsules by a fluidised bed after being coated by the powdering agent and after being at least superficially dried by the hot gas in the spraying tower.

Preferably, the fluidised bed is supplied with a gas having a temperature in the range of 40 to about 100° C., meaning that gas having a temperature in this range is supplied from below the bed through small apertures to fluidise/intercept the capsules. Preferably, the temperature of the gas is in the range of 65 to 90° C. Generally, the gas is air. Similarly to the spraying zone, the method of the present invention again provides for comparatively high temperatures in the fluidised bed in view of the prior art. Again a shorter drying period has resulted in surprisingly lower loss of volatile ingredients.

The capsules obtainable and/or obtained by the method of the present invention will have a flavour and/or fragrance ingredient load of 1-50 wt. %. According to a preferred embodiment, the load of the ingredient is in the range of 18-50 wt. %. It is thus possible to have high ingredient loads in the range of 20-40 wt. %, preferably 25-38 wt. % and more preferably 27 to 35 wt. %. The high ingredient loads obtainable by the present invention are a result of the use of comparatively high temperatures of the inlet gas and are clearly superior to volatile ingredient loads obtained by similar processes of the prior art. The high loads are further a consequence of reduced loss of volatiles achieved by the present method.

The high ingredient loads of the capsules of the invention are thus also a consequence of the comparatively low relative contribution of the coating provided by the powdering agent on the surface of the capsules of the invention. Of course, the term “surface” in this context does not exclude the possibility of one or more further outer coatings, possibly coating the layer provided by the powdering agent. For example, one can easily envisage a further lipid-based coating.

Generally, the contribution of the powdering agent to the total weight of the capsules may be in the range of 0.1 to 30% by weight, which corresponds to a preferred embodiment of capsules according to the present invention. However, the amount of powdering agent may be lower, from 0.1 to 27 wt. %, preferably from 0.5 to 25 wt. %, more preferably from 1 to 20 wt. % and most preferably from 12 to 15 wt. % of powdering agent. In most advantageous embodiment, the amount of powdering agent makes up ≦10 wt. % of the total weight of the capsules of the present invention.

The present invention further provides capsules obtainable and/or obtained by the method of the present invention.

The present invention provides a food product comprising the capsules of the invention and/or the capsules obtainable by the method of the invention. Products may be, for example, food products, in which the encapsulated ingredient is a flavouring ingredient.

The present invention further encompassed perfumed products comprising the capsules of the invention, in which the ingredient is a perfuming composition, for example a perfume, an eau-de-toilette, or another composition of perfuming ingredients, optionally further comprising solvents and/or other adjuvants. Preferred consumer products thus perfumed include solid detergents, soaps and cleaners in particular.

The following examples illustrate the practice of this invention and its preferred modes. It will be understood, however, that these examples are not intended to limit the scope of the invention. Other embodiments of the capsules of the present invention may readily be prepared on the basis of the general teaching herein and the following examples.

### EXAMPLES

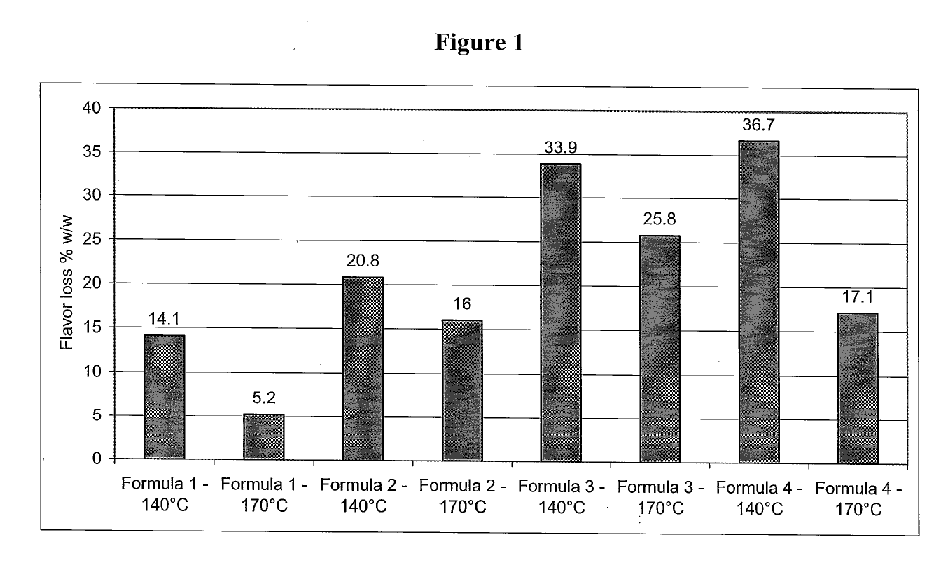

Examples 1-8 below were carried out with samples prepared on the basis of the components listed in Table 1. In addition, the table indicates the results obtained in each case, such as the content of the final starch fraction, final flavour load and flavour loss during the preparation process. In all examples, vapour pressure is expressed in Pa at 25° C. and was determined for each ingredient compound with the “EPI suite” software mentioned above. The results of examples 1 to 8 are also summarized in FIG. 1.

### Example 1

### Drying of Formula 1 with Inlet Air at 140° C.

A solution was prepared by mixing 295 g of Capsul® (supplied by National Strarch), 5 g of citric acid and 500 g of warm water at 50° C. in a vessel until the starch was completely dissolved. The solution was then maintained at 40° C. under gentle stirring. 200 G of limonene were poured into the above-described solution, and homogenized using a high shear rotor/stator mixer Ultra Turrax T50 rotating at 10000 rpm, until the average droplet size of the emulsion was below 2 microns. Limonene has a vapour pressure of 193 Pa.

TABLE 1
Inlet temperatures and compositions of matrix materials with respective flavour loss

| | | | | | | | | Inlet | Final native | | |
|---|---|---|---|---|---|---|---|---|---|---|---|
| | | PG | Sucrose | Capsul ® | Citr. ac. | Limonene | H₂O | gas | starch (coating) | Final flavour load | Flavour loss |
| Formula | Example | (g) | (g) | (g) | (g) | (g) | (g) | T° C. | fraction w/w | w/w | % |
| 1 | 1 | — | — | 295 | 5 | 200 | 500 | 140 | 12.1 | 32.0 | 14.1 |
| | 2 | — | — | 295 | 5 | 200 | 500 | 170 | 10.4 | 34.7 | 5.2 |
| 2 | 3 | — | 50 | 245 | 5 | 200 | 500 | 140 | 10.6 | 30.9 | 20.8 |
| | 4 | — | 50 | 245 | 5 | 200 | 500 | 170 | 10.0 | 32.3 | 16.0 |
| 3 | 5 | 50 | 50 | 195 | 5 | 200 | 500 | 140 | 18.3 | 25.0 | 33.9 |
| | 6 | 50 | 50 | 195 | 5 | 200 | 500 | 170 | 17.8 | 27.2 | 25.8 |
| 4 | 7 | 50 | — | 245 | 5 | 200 | 500 | 140 | 21.8 | 23.2 | 36.7 |
| | 8 | 50 | — | 245 | 5 | 200 | 500 | 170 | 14.3 | 30.5 | 17.1 |

200 G of native Starch type B from Roquette Frères SA were first introduced into a pilot plant multi-stage drier (Niro FSD0.8) and recycled in closed loop continuously all along the process since this dryer is equipped to return the fine particles back into the drying chamber. A cloud of native starch particles was thus created inside the drier.

After 10 minutes, the emulsion was sprayed into this cloud using a two-fluid nozzle. This nozzle had a diameter of 1 mm and was fed with compressed air at a rate of 25 ml/min. The feed flow rate was maintained at 0.057 l/min using a gear pump.

The main air stream arriving on top of the chamber was maintained at 140° C. with a flow rate of 60 kg/h. The fluid bed fitted at the bottom of the chamber was fed at a rate of 22 kg/h with warm air at 50° C.

The third air stream conveying the powdery agent back into the chamber was heated at 50° C. and its flow rate was 10 kg/h.

Since a fix feed flow rate was used, the outlet air temperature of the dryer depended on the amount of water evaporated in the dryer, as well as on the nature (hygroscopicity) of the encapsulating matrix.

The feed was sprayed during 10 minutes and the atomization was then stopped. The granules collected in the fluidized bed were kept in fluidization during 15 more minutes to finish the drying and control their final residual moisture content.

180 G of dry granules were collected in a glass vessel connected to the fluidized bed via a butterfly valve. After discarding the granules having a size below 100 microns and above 700 microns their average diameter was of 350 microns.

Dissolving a fixed amount of granules in cold water and filtering the product, the native starch particles were collected and, after drying, the final amount of dry native starch present in the granules was evaluated. This value was used to calculate the flavor loss.

In this example, 3.5% w/w of native starch was present in the final granules and since the final flavor load was 34% w/w, the flavor loss was 18% w/w of the initial amount of flavor used.

### Example 2

### Drying of Formula 1 with Inlet Air at 170° C.

The same formulation and preparing conditions were used as in Example 1.

The processing conditions were all the same except that the main air stream was heated at 170° C.

In this example, 10.1% w/w of native starch was present in the final granules. The final flavor load was 34.7% w/w and the limonene loss was only 5.2% w/w of the initial amount.

### Examples 3 and 4

### Drying of Formula 2 with Inlet Air at 140° C. and 170° C. Respectively

A formulation using some sucrose in the encapsulating matrix was prepared (see Table 1). The same preparing conditions were used as in Example 1.

The processing conditions were all the same as in Example 1. The inlet air temperature was 140° C. and 170° C. in Example 3 and 4, respectively.

In Example 3, 10.6% w/w of native starch was present in the final granules. The final flavor load was 30.9% w/w and the limonene loss was 20.8% w/w of the initial amount, which is rather economically significant.

In Example 4, where the granules were dried at higher inlet air temperature, 10.0% w/w of native starch was present in the final granules. The final flavor load was 32.3% w/w and the limonene loss was then only 16.0% w/w of the initial amount.

### Examples 5 and 6

### Drying of Formula 3 with Inlet Air at 140° C. and 170° C. Respectively

A formulation using some sucrose and propylene glycol in (PG) in the encapsulating matrix was prepared (see Table 1). The same preparing conditions were used as in Example 1. Sucrose and propylene glycol were dissolved together with Capsul® and citric acid

The processing conditions were all the same as in Example 1. The inlet air temperature was 140° C. and 170° C. in Example 5 and 6, respectively.

In Example 5, 18.3% w/w of native starch was present in the final granules. The final flavor load was 25.0% w/w and the limonene loss was 33.9% w/w of the initial amount.

In example 6 the granules were dried at higher inlet air temperature, and 17.8% w/w of native starch was present in the final granules. The final flavor load was 27.2% w/w and the limonene loss was then 25.8% w/w of the initial amount.

### Examples 7 and 8

### Drying of Formula 4 with Inlet Air at 140° C. and 170° C. Respectively

A formulation using some propylene glycol and no sucrose in the encapsulating matrix was prepared (see Table 1). The same preparing conditions were used as in Example 1. Propylene glycol was dissolved together with Capsul® and citric acid

The processing conditions were all the same as in Example 1. The inlet air temperature was 140° C. and 170° C. in Example 7 and 8 respectively.

In Example 7, 21.8% w/w of native starch was present in the final granules. The final flavor load was only 23.2% w/w and the limonene loss was 36.7% w/w of the initial amount.

In Example 8 the granules were dried at higher inlet air temperature, and 14.3% w/w of native starch was present in the final granules. The final flavor load was 30.5% w/w and the limonene loss was much smaller than in Example 7 with only 17.1% w/w of the initial amount of limonene being lost.

### Example 9

### Encapsulated Strawberry Flavour

A solution was prepared by mixing 300 g of Capsul®, 250 g of Maltodextrine 18DE and 50 g sucrose in 754 g of warm water at 50° C. until complete dissolution of the ingredients. The solution was then maintained at 40° C. under gentle stirring. 400 G of a strawberry type flavor (origin: Firmenich SA, Geneva, Switzerland) was poured into the above describe solution, and homogenized using a high shear rotor/stator mixer Ultra Turrax T50 rotating at 10000 rpm.

The strawberry flavour comprised 83 wt. % of solvant (triacetine, the vapour pressure (vp) of which is 0.698 Pa). 17 wt. % of the strawberry flavour is thus provided by flavour ingredients, of which Furaneol® (tradename of Firmenich SA; 14.7 wt. % of ingredients, vp=0.125 Pa) and ethyl butyrate (14.7 wt. % of ingredients, vp=1964 Pa) are the most significant constituents. Further ingredients of the strawberry flavour were 2-methyl butanoic acid (5.9 wt. % of ingredients, vp=149 Pa) and ethyl-2-methyl butanoate (5.9 wt. % of ingredients, vp=1070 Pa), amongst others.

The same process as in Example 1 was used, except for the main air stream inlet temperature that was 190° C. and the fluid bed gas temperature that was 75° C. After discarding the capsules having a size below 200 microns and above 500 microns their average diameter was of 350 microns. In this example, 5.8 wt. % of native starch (powdering agent) was present in the final capsules (coating). The final flavour load was 35.2 wt. % and thus the flavour loss was 10% w/w of the initial amount of flavour used.

### Example 10

### Encapsulated Mint Flavour

A solution was prepared by mixing 300 g of Capsul®, 250 g of Maltodextrine 18DE and 50 g sucrose in 754 g of warm water at 50° C. until complete dissolution of the ingredients. The solution was then maintained at 40° C. under gentle stirring. The menthol was dissolved in a mint flavour and 400 g of this flavour mixture was poured into the above described solution, and homogenized using a high shear rotor/stator mixer Ultra Turrax T50 rotating at 10000 rpm. More than 10 wt. % of the flavour ingredients of the mint flavour were provided by compounds having a vapour pressure above 1 Pa.

The same process was used as in Example 9. After discarding the capsules having a size below 200 microns and above 500 microns their average diameter was of 350 microns. The capsules obtained had 7.1 wt. % of native starch (coating) and a final flavour load of 33.3 wt. %.

### Examples 11 and 12

### Food Products Comprising the Capsules of the Invention

### Example 11

### Sugar-Free Chewing Gum Comprising Encapsulated Flavours

Sugar-free chewing gum was prepared with the ingredients given below:

| Ingredients | Percent (%) |
|---|---|
| Gum base (Cafosa ® Gum Base Co., Spain) | 30.00 |
| Crystalline sorbitol powder | 53.85 |
| Mannitol powder | 4.00 |
| Sorbitol 70% solution | 10.00 |
| Glycerine | 2.00 |
| Acesulfame potassium | 0.05 |
| Aspartame ® | 0.10 |
| Total | 100.00 |

Chewing gums were prepared according to the following, general procedure: crystalline sorbitol, mannitol, acesulfame potassium and Aspartame® were dry blended forming a powder of blended sweeteners. Half of the sweetener's blend was added to a sigma-blade mixer. The gum base was heated to soften it and added to the sigma blade mixer (equipped with a heated water jacket to allow mixing at a temperature of about 55° C.) and mixed for 2 min. Thereafter, the remaining sweetener's blend and all liquid ingredients (sorbitol 70% solution and glycerine) were added to the mixer and further mixed for 7 min. After a total mixing time of 12 minutes, the unflavoured gum base was removed and encapsulated flavours were added thereto (see below). The flavoured gum base was then shaped into the desired thickness and passed through a pellets forming machine (LWS80 from Hermann Linden, Maschinenfabrik GmbH & Co KG, Germany) to make small chewing gum pellets of 2 g each.

Four different samples of chewing gums were thus prepared based on iso-loads of strawberry and mint flavours, respectively. One of these samples was flavoured with 0.57 wt. % of the capsules of Example 9, and, for comparison, one sample was flavoured by addition of an iso-load of strawberry flavour encapsulated by conventional spray drying.

In samples 3 and 4, similarly, chewing gums were flavoured with mint flavour by adding 0.6 wt. % of the capsules of Example 10, and, for comparison, by adding an iso-load of mint flavour encapsulated by conventional spray drying.

In sensory evaluation blind tests, trained panellists found a higher sensory boosting impact and a higher perceived flavour intensity, when chewing the mint-flavoured chewing gum comprising the capsules of the invention, as compared to the analogue flavoured with conventionally spray dried capsules.

### Example 12

### Sugar-Free Hard-Boiled Candy Comprising Encapsulated Flavours

Sugar-free hard-boiled candies were prepared with the ingredients given below:

| | |
|---|---|
| Ingredients | Percent (%) |

Part 1

| | |
|---|---|
| Aspartame ® | 10.00 |
| Acesulfame potassium | 5.00 |
| Water | 85.00 |
| Total | 100.00 |

Part 2

| | |
|---|---|
| Citric acid solution (50% solids) | 0.75 |

Part 3

| | |
|---|---|
| Isomalt ® | 100.00 |
| Water | 30.00 |
| Total | 100.00 |

Aspartame ® and acesulfame potassium were dry blended forming a powder, slowly added into water and mixed to form a homogeneous high intensity sweetener solution.

In a copper pan, 100 g of Isomalt® and 30 g of water were added. The contents of the copper pan were heated to 160° C. under stirring in a gas cooker. At 160° C., the copper pan was removed from the cooker and placed in a water bath at 40° C., and then removed after a few seconds.

For strawberry flavour: When the temperature had reached 135° C., the high intensity sweetener solution (1.0 ml) was added to the Isomalt mixture, followed by addition of the citric acid solution (1.50 ml) and mixed with a spatula. 0.17 wt. % of flavour capsules (Example 9) were carefully added by spreading them on the top surface of molten candy and mixing them well into the molten candy, resulting in 100 wt. % of molten candy including the encapsulated flavour. Finally, the molten candy was poured into ejector-pins of the Teflon® mould. After solidification, the sugar-free hard-boiled candies were manually ejected from the ejector-pins of the Teflon® mould.

For Mint flavour: When the temperature had reached 135° C., the high intensity sweetener solution (1.0 ml) was added and mixed with a spatula. 0.81 wt. % of encapsulated flavor capsules (Example 10) were carefully added by spreading them on the top surface of molten candy and mixing them well into the molten candy, resulting in 100 wt. % of molten candy including the encapsulated flavour. Finally, the molten candy was poured to solidify as described above.

The hard-boiled candies of the invention were compared on blind tests by sensory panel individuals against hard-boiled candies containing iso-loads of strawberry and mint flavours, respectively, encapsulated, however, by screw-extruding molten carrier mass comprising flavours emulsified therein. The hard-boiled candies containing the capsules of the invention had the same initial boosting impact, but exhibited higher flavour intensity over time than the hard-boiled candies flavoured with the capsules obtained by conventional screw-extrusion.

### Examples 13 to 16

### Food Products Comprising the Capsules of the Invention

The in-dough performance of the flavored capsules of the invention was compared with liquid and conventionally spray dried formats for different flavor tonalities. The tonalities that were evaluated in cookie and cracker food products are shown in Table II. The American Association of Cereal Chemists method (AACC)-10-50D was used to prepare cookies.

TABLE II
Flavor Tonalities evaluated in different applications

| Food Application | Flavor Tonality |
|---|---|
| Cookies | Butter |
| Chocolate Cookies | Mint |
| Crackers | Butter |
| Cheese Crackers | Bacon |

The cookies and crackers were prepared in conventional manner using the formulae indicated herebelow, to which there were added iso amounts of each of the appropriate flavors indicated in table II, in three forms for comparison: flavor in liquid form, as a conventional spray dried powder and as powder capsule form obtained according to the invention.

| | |
|---|---|
| Ingredients | Wt. % |

Cookies

| | |
|---|---|
| Sugar (granulated) | 27.51 |
| Vegetable Shortening | 13.54 |
| Salt | 0.44 |
| Sodium bicarbonate | 0.53 |
| Dextrose solution. (4.0% in water) | 10.37 |
| Flour (unbleached, AP) | 47.61 |
| Total | 100.00 |

Chocolate cookies

| | |
|---|---|
| Sugar (granulated) | 26.51 |
| Vegetable Shortening | 12.54 |
| Salt | 0.44 |
| Sodium bicarbonate | 0.53 |
| Dextrose solution. (4.0% in water) | 10.37 |
| Flour (unbleached, AP) | 46.61 |
| Cocoa powder | 3.00 |
| Total | 100.00 |

Cheese crackers

| | |
|---|---|
| Flour (unbleached, AP) | 49.14 |
| Sugar | 2.45 |
| NFDM | 0.82 |
| Starch (Baka-Snak ®) | 2.45 |
| Inactive Dry Yeast | 0.49 |
| Block cheddar | 10.00 |
| Salt | 0.82 |
| Baking soda | 0.29 |
| Monocalcium phosphate | 0.65 |
| Vegetable Shortening | 8.18 |
| Annatto Extract (Warner) 2.7% | 0.16 |
| Savoury Flavor 570593* | 0.40 |
| Ammonium Bicarbonate | 0.98 |
| Water | 23.17 |
| Total | 100.00 |

Butter crackers

| | |
|---|---|
| Flour (unbleached, AP) | 54.82 |
| Sugar | 2.74 |
| NFDM | 0.91 |
| Starch (Baka-Snak ®) | 2.74 |
| Inactive Dry Yeast | 0.55 |
| Salt | 0.91 |
| Baking soda | 0.32 |
| Monocalcium phosphate | 0.73 |
| Vegetable Shortening | 9.14 |
| Ammonium Bicarbonate | 1.10 |
| Water | 26.04 |
| Total | 100.00 |

*Firmenich SA

The cookies were packed packed in Ziploc® type bags (low density polyethylene) and kept at room temperature. After 2 weeks of storage and sensory evaluation, they were packed in heat sealed aluminum foil pouches until 10 weeks of age and subjected to a second sensory evaluation.

### Sensory Evaluation Results

Two sensory tests were conducted at 2 weeks and 10 weeks after baking with a 30 person consumer-model sensory panel on key attributes such as overall flavor intensity, flavor intensity while chewing, flavor intensity after swallowing and overall flavor preference. The test was performed using a balanced random block design and the panel response was recorded on 0-10 point scale. The data was statistically analyzed by using Analysis of Variance.

In all these blind evaluation tests the results were the same: the cookies and crackers containing the flavors encapsulated by the method of the invention were judged to perform consistently better than those containing iso-amounts of flavor in liquid or conventionally spray dried form, and this in all the sensory attributes mentioned above, showing that the flavored capsules of the invention constitute prime flavor systems for bakery applications.

### Example 17

### Preparation of Perfume Containing Capsules According to the Invention

Perfume containing capsules were prepared using the following ingredients:

| Ingredient | Parts by weight |
|---|---|
| Capsul ® from National Starch | 746 |
| Lavander perfume from Firmenich | 450 |
| Native Corn Starch Type B from Roquette | 10 |

### Procedure:

The solids were dissolved in 1196 parts of water and the perfume to be emulsified into this solution using a high shear rotor/stator homogeniser.

Spray-drying of this perfumed emulsion was performed according to the invention as described in Example 1 using air at 150° C. inlet temperature as the hot gas. Using a spray nozzle, the emulsion feed was sprayed in such a way that coarse droplets were formed. These droplets fell into a cloud of Native Corn Starch chosen for its dehydrating and anticaking properties. The powder was “caught” in flight by the wet emulsion droplets and created a protective layer, preventing them from sticking together or onto the chamber wall of the spray-drier. At the bottom of this chamber the powder-coated droplets were collected and dried to give final dry beadlets.

The resulting perfumed granules contained 25.5% of Lavender perfume, determined by steam distillation. Bulk density of the granules was measured at 0.500 g/ml and explosivity was measured at 103 bar×m/s (KST) giving a dust hazard class of ST-1. Average particle size of the granulated perfume was determined at 250 microns.

### Example 18

### Hygroscopy of Granulated Perfume

Hygroscopicity (the tendency to absorb water) of the granulated perfume was determined in a Dynamic Vapor Sorption, commercialised by Surface Measurements Systems Ltd, 3 Warple Mews, Warple Way, London, W3 ORF, at increasing relative humidity (40%, 50%, 60%, 70%, 80%, 90%) to determine the so-called “melting” point of the two powders at 37° C., as well as the difference in weight of the powder which is placed on a balance in the humidity chamber.

The “melting point”, in the context of the present example refers to the relative humidity at which a powder has absorbed so much water that it loses its powdery aspect and starts to flow like a liquid, that is, it “melts”. The specific relative humidity at which this happens can be determined by the weight-loss observed via the release of the encapsulated volatile perfume.

The encapsulated perfume is placed on a balance inside a chamber where the relative air humidity is increased every two hours by 10%, starting from 40% relative humidity. Initially, the exposed sample of microencapsulated perfume increases in weight due to the water-uptake as the humidity increases. If the microencapsulated perfume or flavour remains a powder and does not “melt”, its weight will remain constant over the two hours at constant humidity. If the microencapsulated perfume starts “melting”, the encapsulate is no longer protected inside the capsule matrix, starts evaporating the chamber and the consequent weight loss of the powder is observed.

The granulated perfume of Example 17 was thus tested according to this method and did not “melt” even at a relative humidity of 90%. The analysis showed that the granulated perfume remained stable even at elevated humidity.

### Example 19

### Fragrance Release of Granulated Perfume in Laundry Powder Detergent

A detergent composition was prepared by mixing 7.8 parts sodium dodecyl benzene sulphonate, 4 parts of Dobanol® 45-7 (linear primary alcohol ethoxylate C14-15 7EO), 21 parts sodium carbonate, 30.2 parts Zeolite A, 12 parts sodium sulphate and 25 parts sodium perborate. This composition is a base for a detergent powder composition.

To 110 g of the detergent composition above, there was added 1.000 weight % of the granulated perfume of Example 17, containing 25.5% of encapsulated Lavender perfume, to prepare a detergent according to the invention.

In a comparative detergent, an iso-amount of Lavander perfume encapsulated via a conventional spray-drying process were added to 110 g of the detergent composition.

Both detergent samples were stored at 37° C. and 70% relative humidity for 1 month in a closed paper box. Then a wash was carried out with both aged detergent samples in a conventional automatic washing machine (Miele® Professional WS 5425) of the front loading type at 95° C. with a 2.5 kg load of terry cotton towels. The freshly washed terry cotton towels were evaluated on a blind test by 40 panelists for their olfactive strength and 35 of the 40 panelists found the scent of the terry towels washed with detergent containing granulated perfume according to the invention far stronger when compared to that of the terry towels washed with detergent containing the conventionally encapsulated perfume. In fact, it was observed that the capsules according to the present invention showed a slower dilution rate in the washing medium than those obtained by a classical spray-drying process, the perfume being thus presumably better retained and thus transferred in larger amounts into the textiles treated with the perfumed detergents.

### Example 20

Preparation of Perfume Containing Capsules According to the Invention and Use Thereof in Soaps

A. Perfume Containing Capsules were Prepared Using the Following Ingredients:

| Ingredient | Parts by weight |
|---|---|
| PVOH* (polyvinyl alcohol) | 519 |
| Perfume from Firmenich** | 410 |
| Sucrose | 70 |
| Antifoam | 1 |

*ERKOL ® V03/140; origin: ACETEX EXPERIMENTAL.
**Perfume having a floral, citrus, fruity, green, musky and woody character.

### Procedure:

The solids were dissolved in 2000 parts of water and the perfume to be emulsified into this solution using a high shear rotor/stator homogeniser.

Spray-drying of this perfumed emulsion was performed according to the invention as described in Example 1 using air at 150° C. inlet temperature as the hot gas. Using a spray nozzle, the emulsion feed was sprayed in such a way that coarse droplets were formed. These droplets fell into a cloud of Native Corn Starch chosen for its dehydrating and anticaking properties. The powder was “caught” in flight by the wet emulsion droplets and created a protective layer, preventing them from sticking together or onto the chamber wall of the spray-drier. At the bottom of this chamber the powder-coated droplets were collected and dried to give final dry beadlets.

The resulting perfumed granules contained 25.9% by weight of perfume and 20.7% by weight of native starch.

### B. Soap Base Formula

A standard tallow base ROZ96/01 (PRISAVON 9250, Uniqema, the Netherlands) was used, having the following composition:

| Component | % by weight |
|---|---|
| Total fatty matter: mixture of Sodium Tallowate | 79.5-82.5 |
| and Sodium Palm Kernelate | |
| Water | 10-13 |
| NaCl | 0.3-0.5 |
| Glycerine | 0.2-0.4 |
| Free alkalinity | 0.01-0.05 |

C. Preparation of Soap Bars with Capsules

A control soap was prepared by mixing the oil fragrance at 1% by weight in the standard soap base in a stainless steel bowl with a plastic spatula. After absorption for 10 or 15 minutes the soap was extruded twice between 35° C. and 40° C. to obtain a homogeneous and compact soap slug. The soap slug was cut and the soap stamped, wrapped in a polyethylene film on a RMT press with the 50 g stainless rectangular mould.

Soap bars containing the perfumed capsules according to the invention were prepared in the same manner by mixing the powder in the soap base in the amount required to obtain 1% by weight of fragrance in the soap fragrance.

### D. Evaluation and Results

The olfactive evaluation of the soap bars was done by experts on blind tests and showed that the soap bars containing the perfumed capsules performed significantly better than bars perfumed with just liquid oil, the perfume diffusion and blooming effect upon use having been judged better, when compared to the control soap bars containing just liquid oil.

1.-20. (canceled)

21. A process for preparing capsules having an average diameter in the range of 100 to 2000 μm and containing an encapsulated flavour or fragrance ingredient or composition, which process comprises:
a) preparing an aqueous solution, suspension or emulsion that includes the flavor or fragrance ingredient in a dissolved, suspended or emulsified form, along with matrix materials and water,
b) dispersing the solution, suspension or emulsion in the form of drops having a mean diameter of 100 to 2000 μm into a spraying tower,
c) introducing, simultaneously with the dispersing, a powdering agent into the spraying tower to obtain a coating of the powdering agent on the drops of the solution, suspension or emulsion,
d) supplying, simultaneously with the dispersing, a hot gas into the spraying tower, wherein the hot gas is supplied at a temperature in the range of 130-250° C. to at least partially dry the drops and form capsules, and
e) removing the powdering agent coated capsules from the spraying tower.

22. The process of claim 21, wherein the temperature of the hot gas that is supplied is above 150° C.

23. The process of claim 21, which further comprises intercepting the capsules, once they have been coated by the powdering agent and at least superficially dried by the hot gas in the spraying tower, by a fluidised bed.

24. The process of claim 23, in which the fluidised bed is supplied with a gas having a temperature in the range of 40 to about 100° C.

25. The process of claim 21, in which the solution, suspension or emulsion comprising the flavour or fragrance ingredient, the matrix components and water has a dry-matter content in the range of 45-80 wt. %, relative to the total weight of emulsion.

26. The process of claim 21, wherein the flavour or fragrance ingredient comprises at least 10 wt. % of chemical compounds having a vapor pressure of or above 0.007 Pa at 25° C.

27. The process of claim 21, in which the obtained capsules have a flavour or fragrance ingredient load of 18-50 wt. %.

28. The process of claim 21, in which the powdering agent is selected from the group consisting of starch, starch derivatives, talc, bentonite, silicon dioxide, calcium, magnesium, aluminium or potassium silicates, sodium, potassium or calcium aluminosilicates, calcium, sodium, or magnesium carbonates, calcium or magnesium phosphates, ferric ammonium citrate, microcrystalline cellulose and cellulose derivatives or fibers, aluminium, calcium, sodium, magnesium, potassium or ammonium salts of fatty acids, magnesium oxides, and mixtures comprising two or more of the aforementioned powdering agents.

29. Capsules having an average diameter in the range of 100 to 2000 μm comprising an encapsulated flavor or fragrance ingredient providing a load in the range of 18-40 wt. %, and an exterior coating provided by a powdering agent, whereby the coating provides 0.1 to 30 wt. % of the total weight of the capsules.

30. The capsules according to claim 29, wherein the powdering agent is selected from the group consisting of starch, starch derivatives, talc, bentonite, silicon dioxide, calcium, magnesium, aluminium or potassium silicates, sodium, potassium or calcium aluminosilicates, calcium, sodium, or magnesium carbonates, calcium or magnesium phosphates, ferric ammonium citrate, microcrystalline cellulose and cellulose derivatives or fibers, aluminium, calcium, sodium, magnesium, potassium or ammonium salts of fatty acids, magnesium oxides, and mixtures comprising two or more of the aforementioned powdering agents.
